(19) United States
(12) Patent Application Publication
(10) Pub. No.: US 2026/0017882 A1
(43) Pub. Date: Jan. 15, 2026

(54) Method for Generating a 3D Model from a Single Monocular Image of an Area of Interest

(71) Applicant: Elm Company, Riyadh (SA)

(72) Inventors: Andrew CARNELL, Riyadh (SA); Thariq KHALID, Riyadh (SA); Riad SOUISSI, Riyadh (SA)

(21) Appl. No.: 19/263,097

(22) Filed: Jul. 8, 2025

Related U.S. Application Data
(60) Provisional application No. 63/669,218, filed on Jul. 9, 2024.

(51) Int. Cl. G06T 17/05; G06T 7/11; G06T 17/00; G06V 10/46

(52) U.S. Cl. CPC G06T 17/05; G06T 7/11; G06T 17/005; G06V 10/462

(57) ABSTRACT

A computer-implemented method for generating a 3D model from an image of an area of interest (AOI), the method comprising: analyzing an image of the AOI with a segmentation module generating a depth map by analyzing an output of the segmentation module with a depth map module; and, converting the depth map into a height map and a 3D model of the AOI. A system for generating a 3D model from an image of an area of interest (AOI) and a non-transitory computer-readable medium comprising instructions for performing the method are also disclosed.

### CROSS-REFERENCE TO RELATED APPLICATIONS

This application claims the benefit of priority to U.S. Provisional Application Ser. No. 63/669,218, filed on Jul. 9, 2024, the contents of which is incorporated herein by reference in its entirety.

### TECHNICAL FIELD

The present disclosure generally relates to the field of a computer-implemented method for generating a 3D model from an image of an area of interest (AOI). The present disclosure also relates to a system for generating a 3D model from an image of an area of interest and a non-transitory computer-readable medium for performing the same.

### BACKGROUND

Creating 3D models of cities and urban areas, let alone up-to-date 3D models of those areas, is typically a very involved process involving numerous teams of people and many site visits by these various teams. The process may involve combining work on satellite, drone, UAV and street-level images along with graphic artists and more. As such, these projects typically take many months to complete and can cost hundreds of thousands, if not millions of dollars.

Furthermore, many current methods employ techniques that are unable to capture many depth details beyond that of the basic shape of buildings and ground details without significant investment in on-site teams and hardware.

An approach that can deliver a bare-bones 3D model in a much quicker time frame and with a cost far below that of traditional methods, could significantly enhance the nascent 3D digital twin model creation market, allowing for first-draft models to be created in a relatively very short space of time. Additionally, with the only base requirement being a single, monocular optical satellite image, the model produced using this new methodology can be updated with current ground information with relatively little notice

To produce an up-to-date model, a recently tasked satellite image (or images) is required with a very low angle of incidence (close to 0), low cloud cover and taken during daylight hours. The approach can be performed with optical images of any resolution. However, the higher the resolution the more objects and details one can capture in the model.

The disclosed computer-implemented method for generating a 3D model from an image of an area of interest (AOI), as well as the system and the non-transitory computer-readable medium are configured to overcome one or more of the problems set forth above and/or other problems of the prior art.

### SUMMARY

In accordance with an aspect of the disclosure there is provided a computer-implemented method for generating a 3D model from an image of an area of interest (AOI), the method comprising: analyzing an image of the AOI with a segmentation module; generating a depth map by analyzing an output of the segmentation module with a depth map module; and converting the depth map into a height map and a 3D model of the AOI.

In an embodiment, the segmentation module comprises an image tiler, configured to divide the image into tiles in a random oversampled manner, each tile containing a predetermined number of adjacent pixels.

In an embodiment, dividing the image into tiles in an oversampled manner comprises: allocating at least one pixel of the image to more than one tile, creating overlapping tiles.

In an embodiment, the segmentation module comprises a segmentation model, comprising creating a segmented mask of salient objects in the AOI, the segmented mask defining segmented objects; and creating overlapping image tiles by randomly oversampling an area defined by each segmented object in the segmentation mask.

In an embodiment that comprises a plurality of images of the AOI, the method comprises: analyzing the plurality of images with a segmentation model to create a plurality of outputs of the segmentation model, wherein each output of the segmentation model corresponds to one image of the plurality of images; aligning the plurality of outputs of the segmentation model to project the plurality of images into a single coordinate system; creating a cumulative mask; creating a non-transient mask; and selecting one of the plurality of outputs of the segmentation module based on a comparison with the non-transient mask.

In an embodiment, the AOI may comprise at least one of a city, part of a city, or an urban area and the segmentation module comprises a Segment Anything Model.

In an embodiment, analyzing an output of the segmentation module with the depth map module comprises: processing the overlapping image tiles with a depth model to create overlapping depth tiles; and averaging overlapping areas of the depth tiles to create an output depth map.

In an embodiment, analyzing an output of the segmentation module with the depth map module further comprises processing the overlapping depth tiles to remove artifacts.

In an embodiment, the depth map module comprises a Depth Anything Model.

The method may further comprise filtering out the segmented objects by size prior to generating the depth map by analyzing the output of the segmentation module with a depth map module.

In an embodiment, the method further comprises pre-processing the image of the AOI prior to analyzing the image with the segmentation module.

In an embodiment, converting the depth map into the height map of the AOI comprises using a weighting method for converting color values of the depth map to greyscale, wherein coloring of the depth map is associated with relative height. Converting the depth map into a height map and a 3D model of the area of interest AOI may comprise converting the depth map into an absolute height map and a 3D model of AOI in a process that includes: convolving a Digital Elevation Model (DEM) or a Digital Terrain Model (DTM) to one of the output of the segmentation model or the depth map to create an elevation map; performing an absolute height calculation to create an absolute height map; and convert the absolute height map into a 3D model of the AOI.

In an embodiment, performing an absolute height calculation to create an absolute height map comprises: selecting a segmented object located on the flattest area of the elevation map; calculating the absolute height of the selected object based on a length of its shadow and an angle of the sun; calculating the absolute height of the rest of the segmented objects based on the absolute height of the selected segmented object and a relative height of the rest of the segmented objects; and importing the segmented objects' absolute heights onto the elevation map to create an absolute heights map.

In an embodiment, performing an absolute height calculation to create an absolute height map comprises: performing shadow segmentation to create segmented shadows corresponding to each segmented objects; displacing the segmented shadow of each of the segmented objects to match the segmented shadow vertexes to the corresponding segmented object vertexes to define a shifting vector; calculating the absolute height of the segmented objects based on a length of the shifting vector and an angle of the sun; and importing the segmented objects' absolute heights onto the elevation map to create an absolute heights map.

In an embodiment, the method may further comprise storing the output of the segmentation model in a tree data structure to enable parallelized computation for analyzing the output of the segmentation module with a depth map module.

There is also disclosed a system for generating a 3D model from an image of an area of interest (AOI) comprising a processor, the processor configured to: analyze an image of the AOI with a segmentation module; generate a depth map by analyzing an output of the segmentation module with a depth map module; and convert the depth map into a height map and a 3D model of the AOI.

In an embodiment, the processor used in the system may further configured to: analyze a plurality of images of the AOI with a segmentation model to create a plurality of outputs of the segmentation model, wherein each output of the segmentation model corresponds to one image of the plurality of images; align the plurality of outputs of the segmentation model to project the plurality of images into a single coordinate system; create a cumulative mask; create a non-transient mask; and select one of the plurality of outputs of the segmentation module based on a comparison with the non-transient mask.

There is further described a non-transitory computer-readable medium comprising instructions which when executed on one or more processors, configure the one or more processors to: analyze an image of an area of interest (AOI) with a segmentation module; generate a depth map by analyzing an output of the segmentation module with a depth map module; and convert the depth map into a height map and a 3D model of the AOI.

### BRIEF DESCRIPTION OF THE DRAWINGS

The accompanying drawings, which are incorporated in and constitute a part of this specification, illustrate some disclosed embodiments and, together with the description, serve to explain the disclosed embodiments. The particulars shown are by way of example and for purposes of illustrative discussion of embodiments of the present disclosure. The description taken with the drawings makes apparent to those skilled in the art how embodiments of the present disclosure may be practiced.

FIG. 1 is a method flow chart illustrating an exemplary method for generating a 3D model from an image of an area of interest (AOI) in accordance with embodiments of the disclosure.

FIG. 2A is a method flow chart illustrating an exemplary method of using a segmentation module in accordance with embodiments of the disclosure.

FIG. 2B is a method flow chart illustrating an exemplary method of using a segmentation model in accordance with embodiments of the disclosure.

FIG. 3 is an example output of a segmentation model in accordance with embodiments of the disclosure.

FIG. 4 is a method flow chart illustrating an exemplary method of using a depth module in accordance with embodiments of the disclosure.

FIG. 5A is an exemplary representation of a depth map in accordance with embodiments of the disclosure.

FIG. 5B is an exemplary representation of a height map in accordance with embodiments of the disclosure.

FIG. 6 is a method flow chart illustrating an exemplary method of selecting an image of an AOI based on the persistence of objects in accordance with embodiments of the disclosure.

FIG. 7 is a method flow chart illustrating an exemplary method of creating an absolute height map in accordance with embodiments of the disclosure.

FIGS. 8A and 8B are method flow charts illustrating exemplary methods of performing an absolute height calculation in accordance with embodiments of the disclosure.

FIG. 9 is a schematic representation of using shadow segmentation to define a shifting vector in accordance with embodiments of the disclosure.

FIG. 10 is an exemplary representation of an explorable and editable 3D model of an AOI in accordance with embodiments of the disclosure.

FIG. 11 is an exemplary representation of segmented objects organized into a quadtree in accordance with embodiments of the disclosure.

FIG. 12 is an exemplary flow chart showing how images of AOIs may be transmitted to the model via a network connection, and the output of the model may also be transmitted via a network connection in accordance with embodiments of the disclosure.

### DETAILED DESCRIPTION

In one embodiment, there is disclosed a system that will take as input a monocular RGB satellite image of the Area of Interest (AOI). This may then be processed with histogram stretching techniques and normalization to ensure quality of input. The image may be passed either through a segmentation model to obtain object segmentation masks over the AOI or, be oversampled randomly throughout the AOI with image tiles of the required resolution.

The processed optical image is then split into tiles either in a random, oversampled manner (‘Image Tiler’) across the AOI or using the segmentation masks object areas only (‘Segmentation Model Processor’) and each tile is passed through a Depth detection model. The tiles may then be reconstituted into a whole image once again to create a Depth map of the entire AOI, with averages being taken over all values for pixels with overlap.

Optionally, the depth map may be normalized and convolved with a Digital Elevation Map (DEM)/Digital Terrain Map (DTM) here, to show the model sitting within its local landscape.

The depth image may then be further processed and transformed into a 16-bit heightmap.png or tiff file, which itself may then be loaded into a 3D editor such as Unity or Unreal Engine, where it can be explored as full 3D model of the AOI scene.

Specific embodiments of the disclosure will now be described with reference to the appended figures.

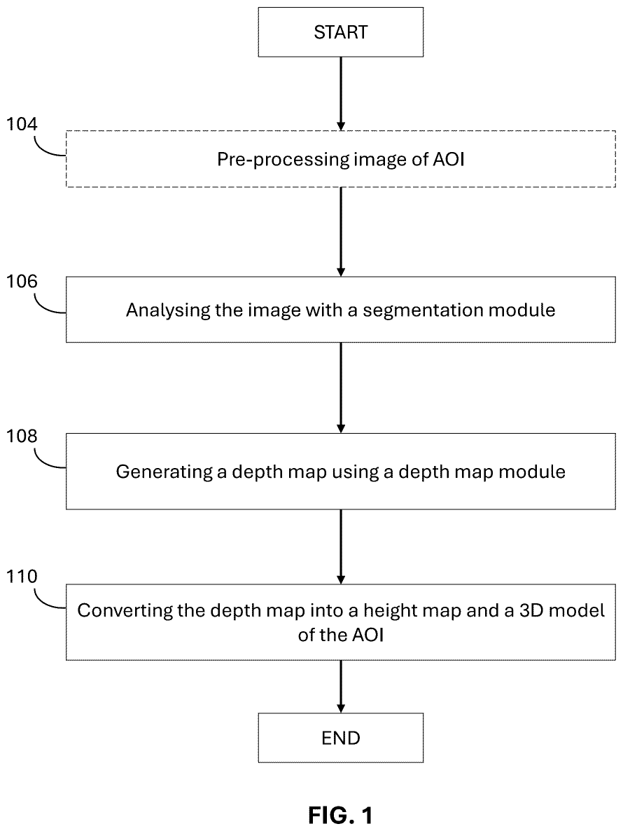

FIG. 1 is a method flow chart illustrating a method 100 for generating a 3D model from an image of an area of interest (AOI). The method commences with an image of the AOI. The image of the AOI may comprise a monocular aerial image of the AOI, or a monocular satellite image of the AOI, with a close to zero angle of incidence, low cloud cover and taken during daylight. In some embodiments, the image (e.g., monocular aerial or satellite image) is captured using focal-infinity optics, a lens configuration where the focus is set to infinity. This setup, common in satellite and high-altitude aerial imaging, may allow the camera to maintain sharp focus (i.e., little to no blur) across the entire scene, regardless of the distance of objects from the sensor. As a result, the captured image may be uniformly sharp from edge to edge. In such embodiments, the 3D model generation is performed without relying on edge sharpness contrast. According to some example embodiments, the AOI may comprise at least one of a city, part of a city, or an urban area.

It should be appreciated that FIG. 1 comprises some steps which are illustrated with a solid border and some steps which are illustrated with a dashed border. The steps which are comprised in a solid border are steps which are comprised in the broadest example embodiments. The steps which are comprised in the dashed border are example embodiments which may be comprised in, or a part of, or are further steps which may be taken in addition to the steps of the broader example embodiments.

In accordance with some example embodiments, at step 104 the method may comprise pre-processing the image of the AOI to ensure that the image is free from properties that might be detrimental to sufficiently perform the at least some steps of the method. For example, the detrimental properties may include noise, the associated pre-processing step being using gaussian blurring filtering, or using a denoising autoencoder. The detrimental properties may also include low contrast, the associated pre-processing step being using histogram stretching techniques such as CLAHE (Contrast Limited Adaptive Histogram Equalization). The detrimental properties may also include poor lighting, the associated pre-processing step being normalizing the brightness and/or contrast over the image to a standard range.

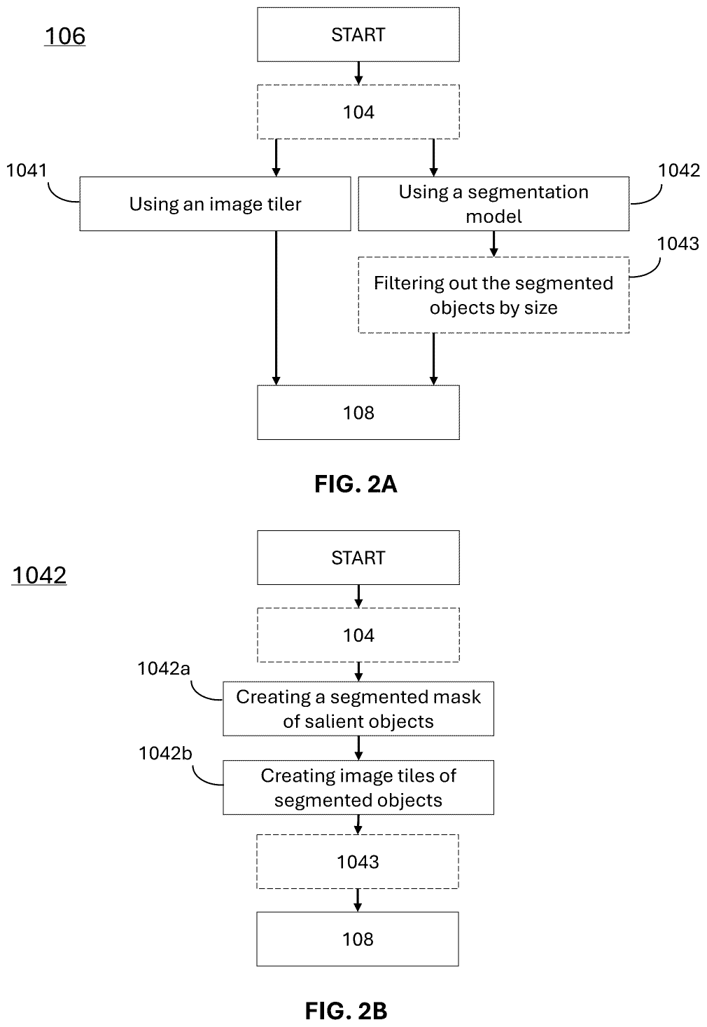

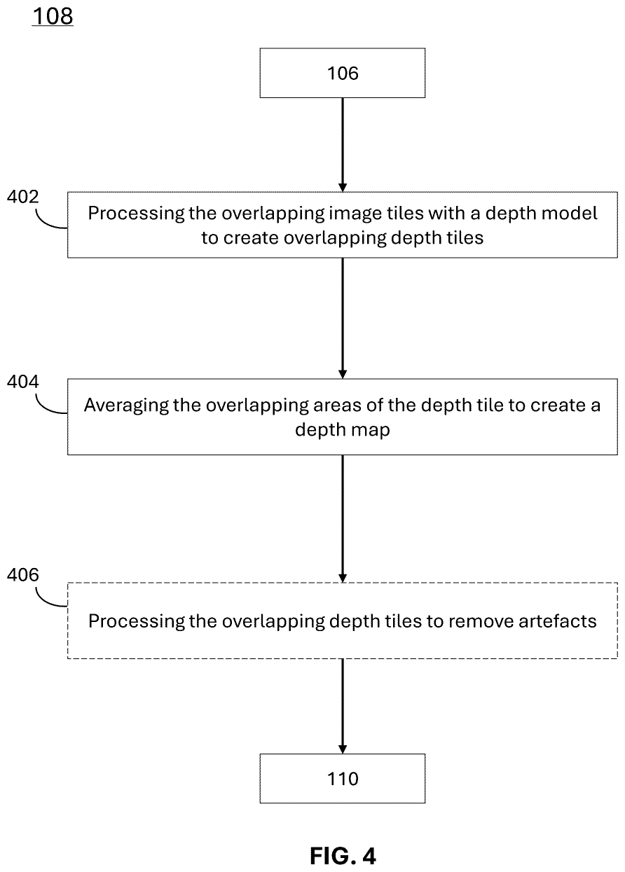

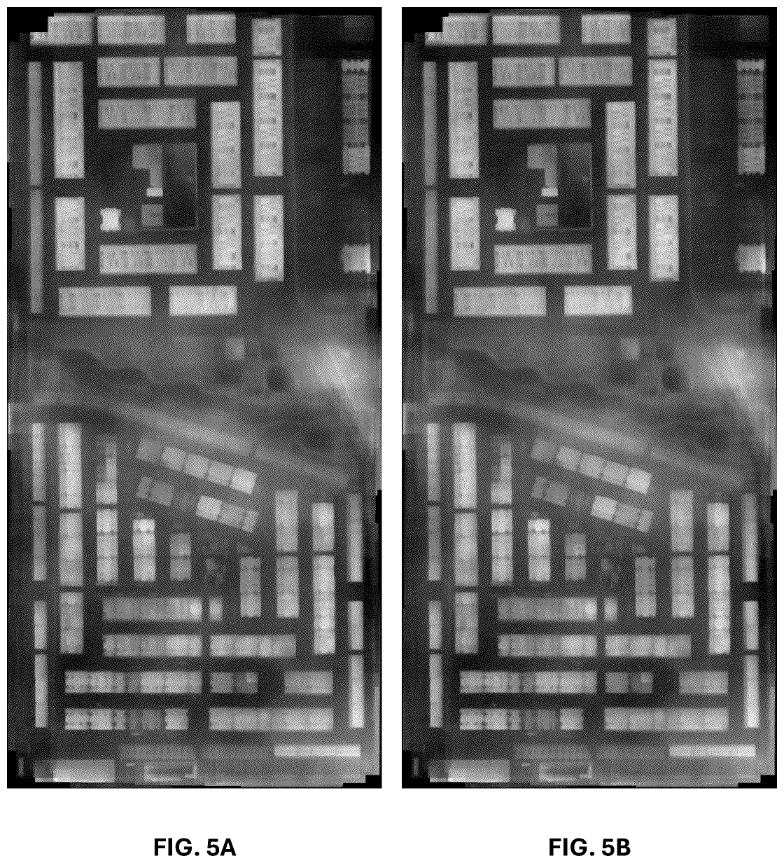

At step 106, the method analyses the image of the AOI with a segmentation module. Further details of how this is done are explained with reference to FIG. 2A. At step 108, a depth map is generated by analyzing the output of the segmentation module with a depth map module. Further details of this are explained with reference to FIG. 4. At step 110, the depth map is converted into a height map and a 3D model of the AOI. Converting the depth map into a height map of the AOI may for example comprise using a weighting method for converting the color values of the height map to greyscale, wherein the coloring is associated with relative height, effectively creating a single-channel depth representation of the depth map. An example of a height map is shown in FIG. 5B. Converting the height map into a 3D model may for example be done by Unreal Engine.

FIG. 2A is a flow chart providing further details of method step 106. It should be appreciated that FIG. 2A comprises some steps which are illustrated with a solid border and some steps which are illustrated with a dashed border. The steps which are comprised in a solid border are steps which are comprised in the broadest example embodiments. The steps which are comprised in the dashed border are example embodiments which may be comprised in, or a part of, or are further steps which may be taken in addition to the steps of the broader example embodiments.

At step 1041, the segmentation module may comprise an image tiler, shown at step 108, splitting the image into tiles, wherein each tile may comprise a predetermined number of adjacent pixels. The predetermined number of pixels may be dependent on the computing power of the processor configured to carry out the method. The splitting of the image into tiles may be performed in a random oversampled manner, wherein splitting an image into tiles in an oversampled manner comprises allocating at least one pixel of the image to more than one tile, creating overlapping tiles. Splitting the image into tiles in an oversampled manner may provide the model with different views of the AOI and allow for averaging over the AOI in a manner that allows for a smoother output and potentially captures finer details. In some embodiments, this tiling strategy may enhance the robustness of downstream depth estimation by introducing redundancy because each pixel may be analyzed in multiple contexts, which may help mitigate local noise or artifacts. Overlapping tiles may also allow for statistical averaging across predictions, reducing edge effects and improving continuity between adjacent regions. Additionally, random oversampling may ensures that the model is exposed to a diverse set of spatial configurations, which may improve generalization and help capture subtle structural variations within the AOI.

At step 1042, the segmentation module may also comprise a segmentation model, defining segmented objects, as explained with reference to FIG. 2B. The segmentation model may for example comprise a Segment Anything Model, e.g. as disclosed here (Kirilov et al https://arxiv.org/abs/2304.02643). The segmentation model may also comprise a semantic segmentation model to segment the image into known objects. This may allow for the selection of what to include in any subsequent 3D model based on this semantic segmentation map, removing or adding different combinations of objects into the scene. For example, the semantic segmentation model may output pixel-wise masks that delineate object boundaries with high precision, which can be used to isolate buildings, roads, vegetation, and other features of interest. These masks may then guide the downstream depth estimation process by focusing computational resources on semantically meaningful regions. Additionally, the segmentation output may be used to filter out transient or irrelevant objects such as vehicles or temporary structures, thereby improving the stability and interpretability of the resulting 3D model.

According to some example embodiments, at step 1043 the method may comprise filtering out the segmented objects by size. For example, the filtering may be designed to remove segmented objects below a predetermined size, the size of the segmented object being defined by the number of pixels that comprise the segmented object. The predetermined size may be chosen to disregard smaller objects to keep only large, for example, building-size objects.

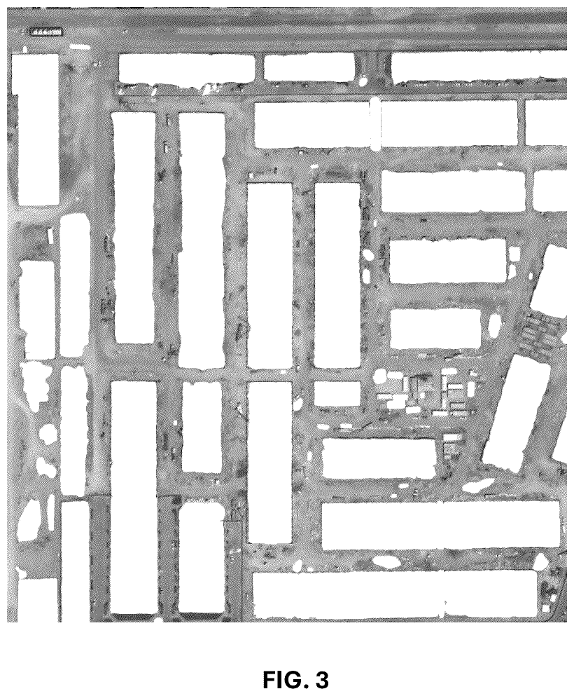

FIG. 2B is a flow chart providing further details of step 1042. At step 1042a, the segmentation model may comprise creating a segmented mask S of salient objects in the AOI, the segmented mask defining segmented objects. An example of a segmented mask S is shown in FIG. 3. At step 1042b, the segmentation model may create overlapping image tiles by randomly oversampling the area defined by each segmented object in the segmentation mask S.

FIG. 4 is a flow chart providing further details of step 108. It should be appreciated that FIG. 4 comprises some steps which are illustrated with a solid border and some steps which are illustrated with a dashed border. The steps which are comprised in a solid border are steps which are comprised in the broadest example embodiments. The steps which are comprised in the dashed border are example embodiments which may be comprised in, or a part of, or are further steps which may be taken in addition to the steps of the broader example embodiments.

At step 402, the overlapping image tiles may be processed with a depth model to create overlapping depth tiles. The depth model may comprise a Depth Anything Model, e.g. as disclosed here (Yang et al https://arxiv.org/abs/2401.10891). At step 404, the overlapping areas of the depth tiles are averaged to create an output depth map D. The averaging of the depth value over the overlapping areas of the depth tiles may be performed to reduce any discontinuity between tiles and increase the fine details captured by the tiles. In accordance with some example embodiments, at step 406 the method may further process the depth tiles to remove any artefact caused by the tiling of the image, wherein the tiling of the image is the creation of overlapping tiles. Such artefact may include gradient, or discontinuity between tiles. The step associated with removing gradient between tiles may include adding a gradient removing module. The step associated with removing discontinuity between tiles may include implementing edge detection techniques, calculating gradient magnitudes over these edges, thresholding these magnitudes over these edges, and applying a smoothing filter over the qualifying edges. An example of a depth map D is presented in FIG. 5A.

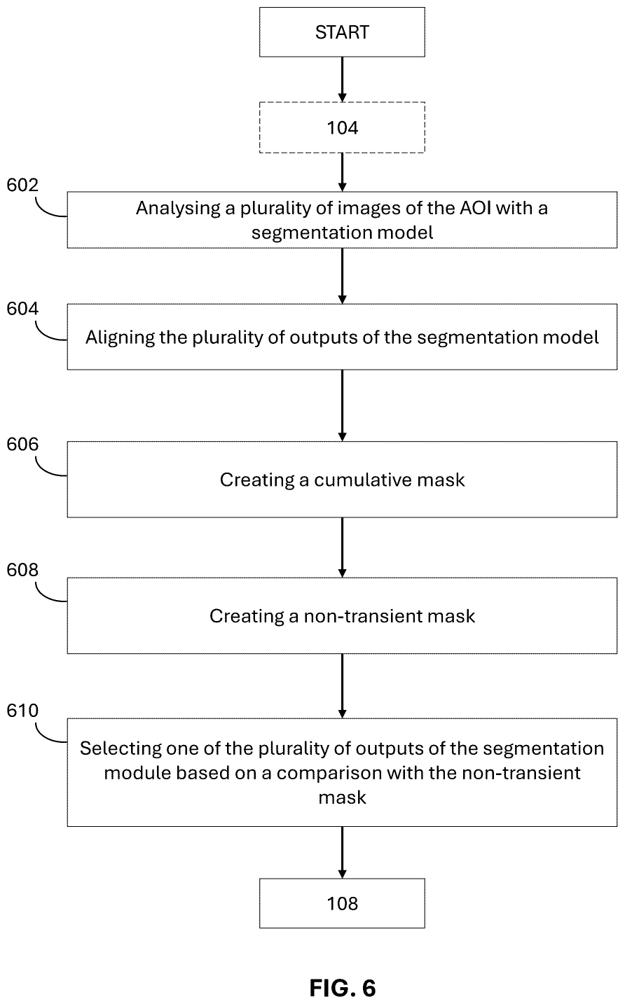

According to some example embodiments, a plurality of images of the AOI, taken at different times, may be available. In such embodiments, the method may include a step of selecting an image of the AOI prior to analyzing the image of the AOI, detailed in FIG. 6. The method of selecting an image of the AOI among a plurality of images of the AOI may enable to factor in the persistence over time of segmented objects in the AOI. A persistent object, showing in a majority of the plurality of images of the AOI may be of interest while creating a 3D model of the AOI. A non-persistent object, showing in small portion of the plurality of images of the AOI may however be of little interest. Non-persistent object may for example include storage containers or prefab offices on construction sites.

FIG. 6 is a flow chart illustrating a method 600 for selecting an image of the AOI among a plurality of AOI. If a plurality of images of the AOI are available, the steps detailed in method 600 may replace step 106 of method 100, detailed in FIG. 1. At step 602, a plurality of images are analysed with a segmentation model, wherein analyzing a plurality of images with a segmentation model comprises creating an output of the segmentation model for each of the plurality of images.

At step 604, the plurality of outputs of the segmentation model are aligned, wherein aligning a plurality of images comprises projecting the plurality of images into a single coordinate system. For example, the images of the AOI may be a geotiff file and therefore contain the information to project the image to the correct location on the surface of the earth. In some embodiments, this alignment process may involve reading embedded geospatial metadata such as coordinate reference systems (CRS), ground control points (GCPs), or affine transformation matrices. These parameters allow each image to be accurately placed within a shared spatial framework, ensuring that corresponding features across different time points are correctly overlaid. The alignment may be performed using geospatial libraries or tools such as GDAL or QGIS, and may include reprojection to a common CRS if the input images use different spatial references.

It is to be appreciated that the aligning step of 604, could instead be performed as an alignment of the plurality of images before they are input into the segmentation model; the alignment step can be performed in either order without affecting the overall method. It may for example be possible to align the plurality of images of the AOI prior to inputting the plurality of images of the AOI into the segmentation model. By doing so, the segmented objects the outputs of the segmentation module (e.g., the segmented objects) would still be aligned.

At step 608, a cumulative mask is created. The cumulative mask may for example be created by summing over all the outputs of the segmentation model at each pixel location. This cumulative mask may then contain a measure of how persistent pixels are over the timeframe spanned by the series of optical images of the AOI. For example, the pixels belonging to the segmented objects that are present in more images will have a value in the cumulative mask that is higher than the pixels of the segmented objects which appear in fewer images. At step 610, a non-transient mask SNT is created by applying a threshold to the cumulative mask. The value of the threshold may be set depending on the desired persistence of the objects to be selected. For example, setting a low threshold could mean that more segmented objects will make it through to the final non-transient mask SNT, while a high threshold, in this case, would mean that only those objects which appear in more images (have higher pixel values in the cumulative mask) will be present in the non-transient mask output SNT.

At step 610, one of the plurality of outputs of the segmentation module is selected based on a comparison with the non-transient mask. According to some example embodiments, the selection of one of the plurality of outputs of the segmentation model may be based on the overlap between the non-transient mask and the outputs of the segmentation model. For example, the model may choose the output of the segmentation model with the most overlap with the non-transient mask in terms of the number of matching segmented objects. The model may also choose the output of the segmentation model with the highest average percentage overlap (IoU, Intersection over Union) over all segmented objects.

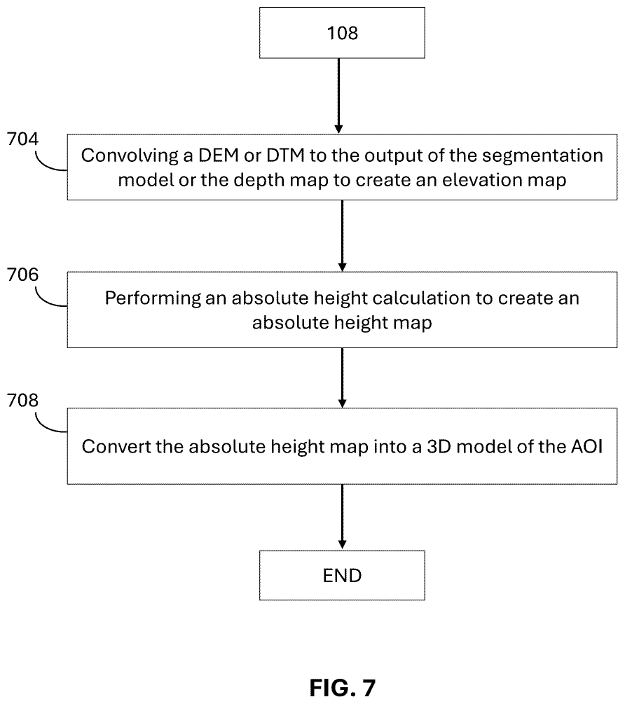

The aforementioned method results in the creation of a height map and a 3D model of the AOI where the heights of the segmented objects are relative to the heights of the other segmented objects. In accordance with some example embodiments, the method may be adapted to give the absolute height of each segmented object. FIG. 7 is a flow chart illustrating a method 700 to convert the depth map into an absolute height map and a 3D model of AOI. If an absolute heights map is desired, the steps detailed in method 700 may replace step 110 of method 100, detailed in FIG. 1. In some embodiments, generating an absolute heights map may enable the resulting 3D model to be geospatially aligned with real-world elevation data, which may be important for applications that require integration with geographic information systems (GIS). Additionally, or alternatively, absolute height values may allow for consistent measurements across different scenes or time periods, as they are not dependent on the relative positioning of objects within a single image. Additionally, or alternatively, models with absolute height data may be used in simulations and analyses that require real-world units, such as urban planning, environmental modeling, or infrastructure assessment.

The method commences at step 704, where a Digital Elevation Model (DEM) or a Digital Terrain Model (DTM) is convolved to either the segmented mask S or the depth map D to create an elevation map. In accordance with some example embodiments, convolving a DEM or a DTM to S or D may comprise aligning the DEM or DTM to S or D to project them in the same coordinate system. Convolving a DEM or a DTM to S or D may further comprise calculating the average elevation for the area covered by each segmented object, creating an elevation map by setting the elevation value of each area covered by each segmented object as the average value calculated previously. Convolving a DEM or a DTM to S or D may further comprise applying a smoothing filter at the boundaries of the areas covered by the segmented objects.

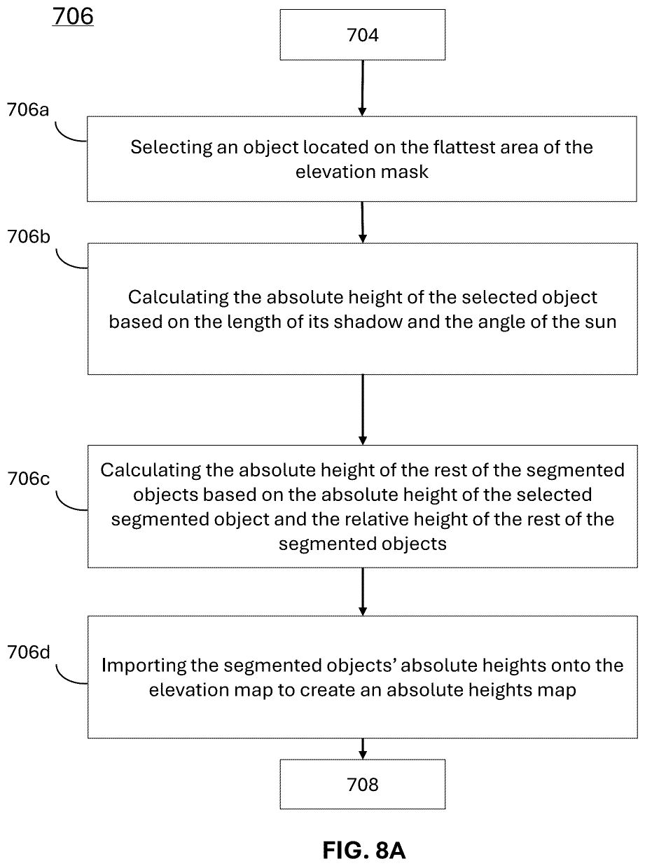

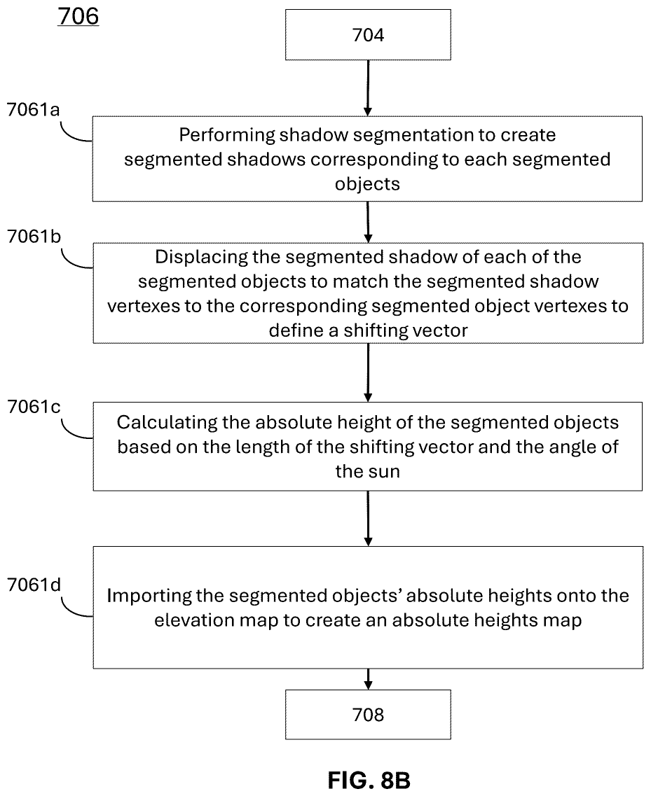

At step 706, an absolute height calculation is performed to create an absolute height map, as detailed in FIG. 8a and FIG. 8b. At step 708, the absolute height map is converted into a 3D model of the AOI, following the method explained previously, for example at step 110 in FIG. 1.

FIG. 8A is a flow chart providing further details of step 706 according to some example embodiments. The method commences at step 706a by selecting an object located on the flattest area of the elevation mask.

At step 706b, the absolute height of the selected segmented object is calculated, based on the length of its shadow and the angle of the sun. For example, the method may comprise calculating an estimate of the absolute height of the segmented object using the known angle of the sun, a, at the time and latitude and longitude of the capture of the AOI image, and the length of its shadow, L obtainable from calculation tools available in software such as ArcGIS. The absolute height H of the selected segmented object may then be given by the following formula: H=L×tan a. At step 706c, the method may further comprise calculating the absolute height of the rest of the segmented objects based on the absolute height of the selected segmented object and the relative height of the rest of the segmented objects. Finally, at step 706e, the method may comprise importing the segmented objects' absolute heights onto the elevation map to create an absolute heights map. This may for example comprise aligning the elevation map with the absolute height of the segmented objects.

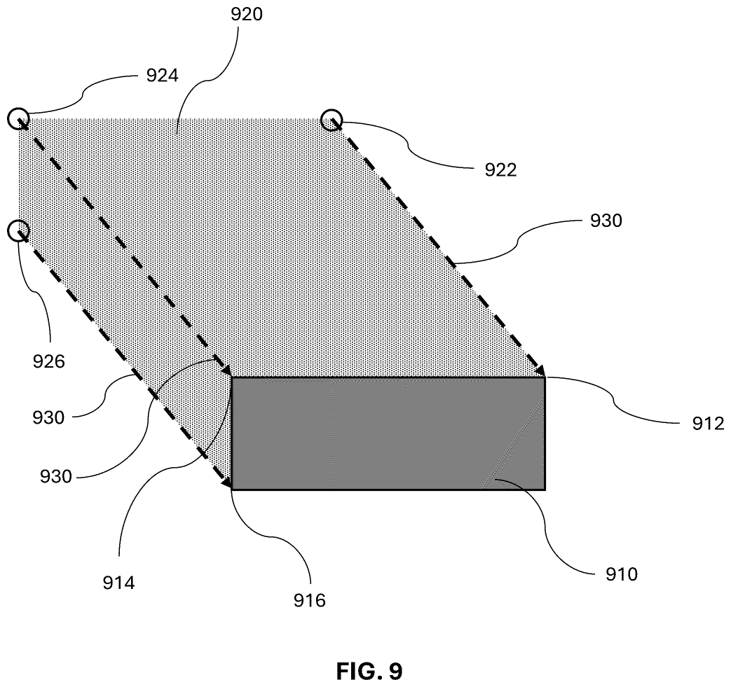

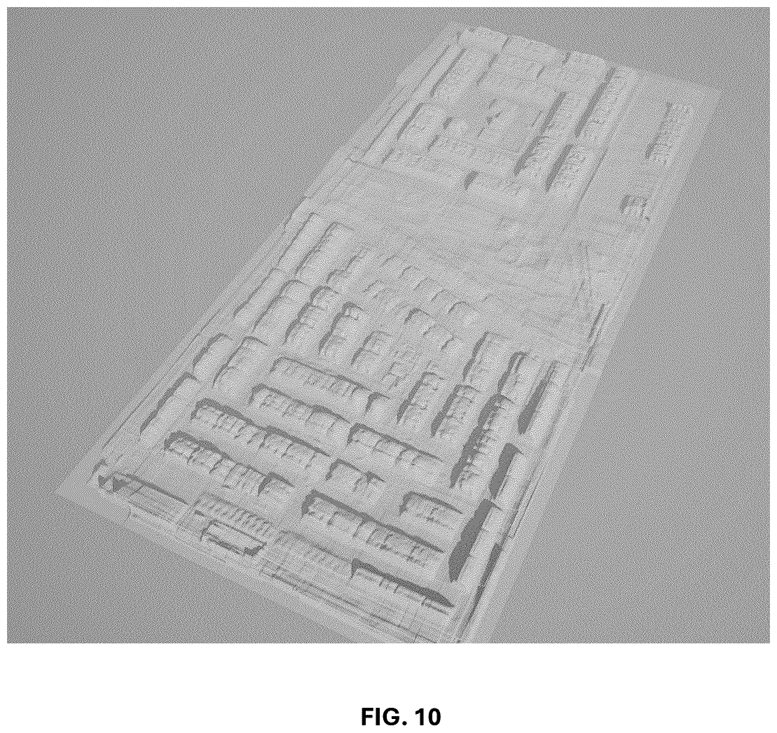

FIG. 8B is a flow chart providing further details of step 706 according to some other example embodiments. The method commences at step 7061a by performing shadow segmentation to create segmented shadows corresponding to each segmented objects wherein the segmented objects have been defined by the segmentation model. An example of a shadow segmentation model may be found here https://arxiv.org/abs/2008.00267. At step 7061b, the segmented shadow of each of the segmented objects is displaced to match the segmented shadows vertexes to the corresponding segmented objects vertexes to define a shifting vector, as illustrated in FIG. 9. In FIG. 9, a segmented object 910 is associated with a segmented shadow 920. Hence, for each vertex 922, 924 and 926 of the segmented shadow, there is an associated vertex 912, 914 and 916 of the segmented object. The vector 930 defined by the displacement of each segmented shadow vertex to match its associated segmented object vertex may be defined as the shifting vector. Although only three vertices are shown in FIG. 9, it is to be appreciated that depending on the number of vertices of the segmented object and the orientation of the illumination, for example, sun rays, the number of vertices associated with the segmented shadow may be different. For example, the number of vertices associated with the segmented shadow may be 1, 2, 3, or any other suitable number of vertices. In accordance with some embodiments, any pair of corresponding segmented object-segmented shadow vertices may be used to define the shifting vector.

At step 7061c, the absolute height of the segmented objects is calculated based on the length of the shifting vector and the angle of the sun. The absolute height H of the segmented objects may then be given by the following formula: H=L×tan a, wherein L is the length of the shifting vector and a is the angle of the sun. Finally, at step 7061d, the method may comprise importing the segmented objects' absolute heights onto the elevation map to create an absolute heights map. This may for example comprise aligning the elevation map with the absolute height of the segmented objects.

FIG. 10 is a picture of an exemplary explorable and editable 3D model of an AOI.

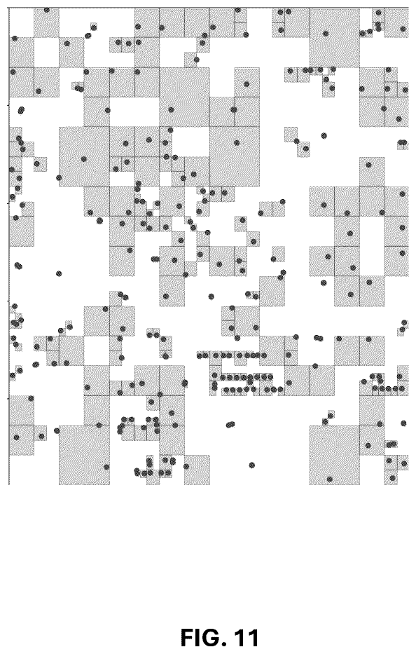

When the AOI becomes of significant size, for example, an entire city, the processing cost and time associated with the creation of the height map and the 3D model may increase significantly. To reduce the processing time, the segmentation mask SNT may for example be stored in a tree data structure such as a quadtree, or a related data structure such as an rtree, as illustrated in FIG. 11. In this way, using the quadtree structure, object masks in proximal regions may be processed on the same processing node, while distant collections of object masks can be processed by other available processing nodes. Processing the map in this parallel manner, as the clusters will not have any local dependencies, will improve processing efficiency and should result in shorter processing time. Processing in this context refers to anything involving the 3D map and the segmented objects within it, including any overlaid data that may be associated with the map. Having the map objects accessible via a tree structure would mean that calculations involving the spatial nature of the map objects and associated data can be more efficiently performed and parallelized.

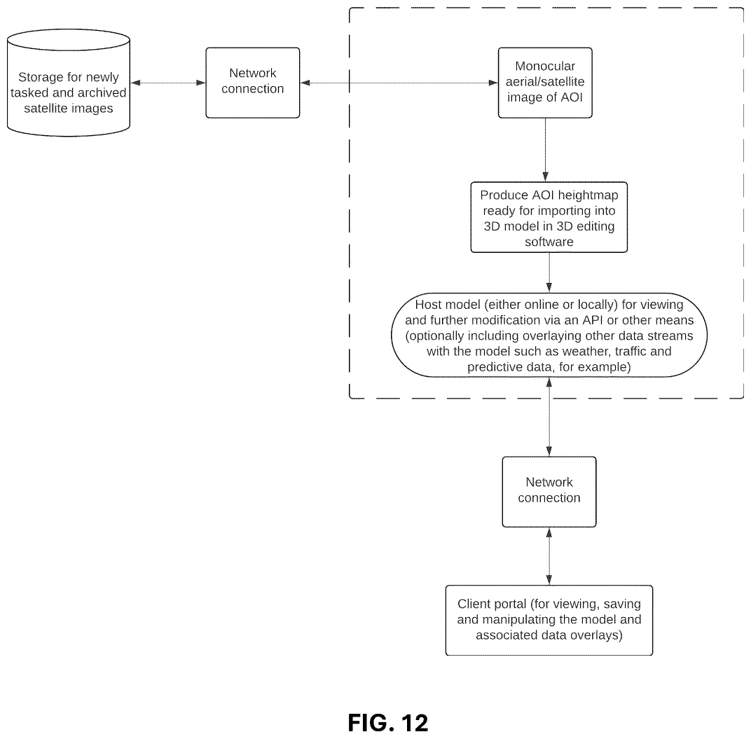

The creation of the height map and 3D model can be hosted either locally or online. If hosted online, images of AOIs may be transmitted to the model via a network connection, and the output of the model may also be transmitted via a network connection, as illustrated in FIG. 12. An API (Application Programming Interface) may also be created to enable viewing and/or further modifying the 3D model of the AOI. The API may further enable overlaying of the 3D model of the API with other data streams, including weather, traffic or predictive data. A client portal may also be created to allow for viewing, saving and manipulating the 3D model and the associated data overlays.

Disclosed embodiments may include any one of the following bullet-pointed features alone or in combination with one or more other bullet-pointed features, whether implemented as a computer-implemented method, device, system, apparatus, and/or a non-transitory computer-readable medium:
a computer-implemented method for generating a 3D model from an image of an area of interest (AOI).
analyzing an image of the AOI with a segmentation module.
generating a depth map by analyzing an output of the segmentation module with a depth map module.
converting the depth map into a height map and a 3D model of the AOI.
a segmentation module comprising an image tiler, configured to divide the image into tiles in a random oversampled manner, each tile containing a predetermined number of adjacent pixels.
dividing the image into tiles in an oversampled manner comprises: allocating at least one pixel of the image to more than one tile, creating overlapping tiles.
the segmentation module comprises a segmentation model, comprising creating a segmented mask of salient objects in the AOI.
the segmented mask defining segmented objects; and creating overlapping image tiles by randomly oversampling an area defined by each segmented object in the segmentation mask.
analyzing a plurality of images with a segmentation model to create a plurality of outputs of the segmentation model, wherein each output of the segmentation model corresponds to one image of the plurality of images.
aligning the plurality of outputs of the segmentation model to project the plurality of images into a single coordinate system.
creating a cumulative mask.
creating a non-transient mask.
selecting one of the plurality of outputs of the segmentation module based on a comparison with the non-transient mask.
AOI comprising at least one of a city, part of a city, or an urban area and the segmentation module comprises a Segment Anything Model.
analyzing an output of the segmentation module with the depth map module comprises: processing the overlapping image tiles with a depth model to create overlapping depth tiles; and averaging overlapping areas of the depth tiles to create an output depth map.
analyzing an output of the segmentation module with the depth map module further comprises processing the overlapping depth tiles to remove artifacts.
a depth map module comprising a Depth Anything Model.
filtering out the segmented objects by size prior to generating the depth map by analyzing the output of the segmentation module with a depth map module.
pre-processing the image of the AOI prior to analyzing the image with the segmentation module.
converting the depth map into the height map of the AOI comprises using a weighting method for converting color values of the depth map to greyscale, wherein coloring of the depth map is associated with relative height.
converting the depth map into a height map and a 3D model of the area of interest AOI that comprises converting the depth map into an absolute height map and a 3D model of AOI in a process that includes: convolving a Digital Elevation Model (DEM) or a Digital Terrain Model (DTM) to one of the output of the segmentation model or the depth map to create an elevation map; performing an absolute height calculation to create an absolute height map; and convert the absolute height map into a 3D model of the AOI.
performing an absolute height calculation to create an absolute height map comprising: selecting a segmented object located on the flattest area of the elevation map; calculating the absolute height of the selected object based on a length of its shadow and an angle of the sun; calculating the absolute height of the rest of the segmented objects based on the absolute height of the selected segmented object and a relative height of the rest of the segmented objects; and importing the segmented objects' absolute heights onto the elevation map to create an absolute heights map.
performing an absolute height calculation to create an absolute height map comprises: performing shadow segmentation to create segmented shadows corresponding to each segmented objects; displacing the segmented shadow of each of the segmented objects to match the segmented shadow vertexes to the corresponding segmented object vertexes to define a shifting vector; calculating the absolute height of the segmented objects based on a length of the shifting vector and an angle of the sun; and importing the segmented objects' absolute heights onto the elevation map to create an absolute heights map.
storing the output of the segmentation model in a tree data structure to enable parallelized computation for analyzing the output of the segmentation module with a depth map module.
a system for generating a 3D model from an image of an area of interest (AOI) comprising a processor, the processor configured to: analyze an image of the AOI with a segmentation module; generate a depth map by analyzing an output of the segmentation module with a depth map module; and convert the depth map into a height map and a 3D model of the AOI.
a processor used in the system may further configured to: analyze a plurality of images of the AOI with a segmentation model to create a plurality of outputs of the segmentation model, wherein each output of the segmentation model corresponds to one image of the plurality of images; align the plurality of outputs of the segmentation model to project the plurality of images into a single coordinate system; create a cumulative mask; create a non-transient mask; and select one of the plurality of outputs of the segmentation module based on a comparison with the non-transient mask.
a non-transitory computer-readable medium comprising instructions which when executed on one or more processors, configure the one or more processors to: analyze an image of an area of interest (AOI) with a segmentation module; generate a depth map by analyzing an output of the segmentation module with a depth map module; and convert the depth map into a height map and a 3D model of the AOI.

The foregoing description is presented for purposes of illustration. It is not exhaustive and is not limited to precise forms or embodiments disclosed. Modifications and adaptations of the embodiments will be apparent from consideration of the specification and practice of the disclosed embodiments. While certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations and/or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps and/or inserting or deleting steps.

The features and advantages of this disclosure are apparent from this detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

Throughout this application, various embodiments of the present disclosure may be presented in a range format. It should be understood that the description in range format is merely for convenience and brevity and should not be construed as an inflexible limitation on the scope of the present disclosure. Accordingly, the description of a range should be considered to have specifically disclosed all the possible subranges as well as individual numeric values within that range. For example, description of a range such as from 1 to 6 should be considered to include subranges such as from 1 to 3, from 1 to 4, from 1 to 5, from 2 to 4, from 2 to 6, from 3 to 6, and so forth, as well as individual numbers within that range, for example, 1, 2, 3, 4, 5, and 6. This applies regardless of the breadth of the range.

Other embodiments will be apparent from consideration of the specification and practice of the embodiments disclosed herein. It is intended that the specification and examples be considered as example only, with a true scope and spirit of the disclosed embodiments being indicated by the following claims.

We claim:

1. A computer-implemented method for generating a 3D model from an image of an area of interest (AOI), the method comprising:
analyzing an image of the AOI with a segmentation module;
generating a depth map by analyzing an output of the segmentation module with a depth map module; and,
converting the depth map into a height map and a 3D model of the AOI.

2. The method of claim 1, wherein the segmentation module comprises an image tiler, configured to divide the image into tiles in a random oversampled manner, each tile containing a predetermined number of adjacent pixels.

3. The method of claim 2, wherein dividing the image into tiles in an oversampled manner comprises: allocating at least one pixel of the image to more than one tile, creating overlapping tiles.

4. The method of claim 1, wherein the segmentation module comprises a segmentation model, comprising:
creating a segmented mask of salient objects in the AOI, the segmented mask defining segmented objects; and,
creating overlapping image tiles by randomly oversampling an area defined by each segmented object in the segmentation mask.

5. The method of claim 1, comprising a plurality of images of the AOI, and the method comprises:
analyzing the plurality of images with a segmentation model to create a plurality of outputs of the segmentation model, wherein each output of the segmentation model corresponds to one image of the plurality of images;
aligning the plurality of outputs of the segmentation model to project the plurality of images into a single coordinate system;
creating a cumulative mask;
creating a non-transient mask; and
selecting one of the plurality of outputs of the segmentation module based on a comparison with the non-transient mask.

6. The method of claim 1, wherein the AOI may comprise at least one of a city, part of a city, or an urban area.

7. The method of claim 1, wherein the segmentation module comprises a Segment Anything Model.

8. The method of claim 4, wherein analyzing an output of the segmentation module with the depth map module comprises:
processing the overlapping image tiles with a depth model to create overlapping depth tiles; and,
averaging overlapping areas of the depth tiles to create an output depth map.

9. The method of claim 8, wherein analyzing an output of the segmentation module with the depth map module further comprises processing the overlapping depth tiles to remove artefacts.

10. The method of claim 1, wherein the depth map module comprises a Depth Anything Model.

11. The method of claim 4, comprising filtering out the segmented objects by size prior to generating the depth map by analyzing the output of the segmentation module with a depth map module.

12. The method of claim 1, comprising pre-processing the image of the AOI prior to analyzing the image with the segmentation module.

13. The method of claim 1, wherein converting the depth map into the height map of the AOI comprises using a weighting method for converting color values of the depth map to greyscale, wherein coloring of the depth map is associated with relative height.

14. The method of claim 4, wherein converting the depth map into a height map and a 3D model of the area of interest AOI comprises converting the depth map into an absolute height map and a 3D model of AOI, comprising:
convolving a Digital Elevation Model (DEM) or a Digital Terrain Model (DTM) to one of the output of the segmentation model or the depth map to create an elevation map;
performing an absolute height calculation to create an absolute height map; and,
convert the absolute height map into a 3D model of the AOI;

15. The method of claim 14, wherein performing an absolute height calculation to create an absolute height map comprises:
selecting a segmented object located on the flattest area of the elevation map;
calculating the absolute height of the selected object based on a length of its shadow and an angle of the sun;
calculating the absolute height of the rest of the segmented objects based on the absolute height of the selected segmented object and a relative height of the rest of the segmented objects; and,
importing the segmented objects' absolute heights onto the elevation map to create an absolute heights map.

16. The method of claim 14, wherein performing an absolute height calculation to create an absolute height map comprises:
performing shadow segmentation to create segmented shadows corresponding to each segmented objects;
displacing the segmented shadow of each of the segmented objects to match the segmented shadow vertexes to the corresponding segmented object vertexes to define a shifting vector;
calculating the absolute height of the segmented objects based on a length of the shifting vector and an angle of the sun; and,
importing the segmented objects' absolute heights onto the elevation map to create an absolute heights map.

17. The method of claim 4, comprising storing the output of the segmentation model in a tree data structure to enable parallelized computation for analyzing the output of the segmentation module with a depth map module.

18. A system for generating a 3D model from an image of an area of interest (AOI) comprising a processor, the processor configured to:
analyze an image of the AOI with a segmentation module;
generate a depth map by analyzing an output of the segmentation module with a depth map module; and,
convert the depth map into a height map and a 3D model of the AOI.

19. The system of claim 18, wherein the processor is further configured to:
analyze a plurality of images of the AOI with a segmentation model to create a plurality of outputs of the segmentation model, wherein each output of the segmentation model corresponds to one image of the plurality of images;
align the plurality of outputs of the segmentation model to project the plurality of images into a single coordinate system;
create a cumulative mask;
create a non-transient mask; and
select one of the plurality of outputs of the segmentation module based on a comparison with the non-transient mask.

20. A non-transitory computer-readable medium comprising instructions which when executed on one or more processors, configure the one or more processors to:
analyze an image of an area of interest (AOI) with a segmentation module;
generate a depth map by analyzing an output of the segmentation module with a depth map module; and,
convert the depth map into a height map and a 3D model of the AOI.
